(19) United States
(12) Patent Application Publication
(10) Pub. No.: US 2025/0124752 A1
(43) Pub. Date: Apr. 17, 2025

(54) DIGITAL KEY AUTHENTICATION CONTROLLER FOR VEHICLE AND METHOD FOR GENERATING pre-derived ultra wide band ranging secure key

(71) Applicants: Hyundai Motor Company, Seoul (KR); Kia Corporation, Seoul (KR)

(72) Inventor: Yong Ho Shin, Hwaseong (KR)

(21) Appl. No.: 18/830,241

(22) Filed: Sep. 10, 2024

(30) Foreign Application Priority Data
Oct. 13, 2023 (KR) 10-2023-0136702

(51) Int. Cl. G07C 9/00; G01S 13/02; H04W 4/029

(52) U.S. Cl. CPC G07C 9/00309; G01S 13/0209; H04W 4/029; G07C 2209/63

(57) ABSTRACT

A method is configured to generate a pre-derived ultra wide band (UWB) ranging secure key (URSK) according to the ranging result of a digital key, and a digital key authentication controller for a vehicle is configured to authenticate the URSK. The method for generating the pre-derived URSK includes steps of: determining a location of the digital key in relation to the vehicle according to a UWB ranging; determining a time of generating the pre-derived URSK according to the locations of the digital key; and generating the pre-derived URSK according to the time. The method may determine generation of the pre-derived URSK that is not interfered with the authentication of an active URSK according to the ranging result of the digital key, and may control the time of generating each pre-derived URSK according to first to third locations.

### CROSS-REFERENCE TO RELATED APPLICATIONS

The present application claims under 35 U.S.C. § 119(a) the benefit of Korean Patent Application No. 10-2023-0136702, filed on Oct. 13, 2023, the entire contents of which is incorporated herein for all purposes by this reference.

### BACKGROUND

### (a) Technical Field

The present disclosure relates to an ultra wide band (UWB)-based digital key system that uses smartphones or smartwatches like a smart key of a vehicle, and more particularly, to a method for generating a pre-derived ultra wide band ranging secure key (URSK) and a digital key authentication controller for a vehicle for the same.

### (b) Description of the Related Art

In an ultra wide band (UWB)-based digital key system which uses a smartphone or smartwatch (for example, APPLE Watch, and hereinafter referred to as “smartphone”) like a smart key of a vehicle, passive vehicle control functions such as opening and closing of a vehicle door and a vehicle start may be provided.

At this time, the passive vehicle control function may include a function that allows the vehicle to determine the location of the key and perform necessary operations even if the user does not directly manipulate the key.

For this passive vehicle control operation, real-time location ranging (also called “localizing”, corresponding to a state in which the location of the digital key can be measured in real time through UWB communication) is performed between UWB modules mounted on each vehicle and smartphone. However, technically, ranging cannot be started with multiple smartphones at the same time, and can only be started with one digital key at a time.

At this time, the operation process of UWB ranging for the digital key is as follows: Ranging trigger occurs→Check UWB ranging secure key (URSK)→Create URSK if it does not exist→Ranging session setup→Check ranging results.

Additionally, it is necessary to minimize the ranging session operation time by creating a pre-derived URSK in advance for use in the next ranging session, separately from the active URSK currently used in the ranging session.

Generally, in order to generate a URSK, a vehicle digital key authentication controller occupies the operation of a unique security area such as Secure Element, so if the occupation operation of another Secure Element occurs simultaneously, it may naturally cause a delay in the operation.

Here, the occupation operation of another Secure Element is to authenticate whether the actual digital key has the authority to use the vehicle. If an operation delay occurs, the user who uses the digital key may feel a delay in the operation of the vehicle starting, vehicle door lock/door unlock, warning, etc., and the operation may be canceled due to exceeding the authentication waiting time, and this may be mistaken for an intermittent breakdown or non-operation of the vehicle.

The creation of a pre-derived URSK for use in the next ranging session has lower priority than authentication for immediate vehicle operation, but it may have a characteristic that must be created in the current ranging session for the next ranging session.

In a UWB-based digital key system, as shown in FIG. 1, when ranging for the digital key begins (S10), a pre-derived URSK for use in the next ranging session is created (S20), and it is possible to determine whether the ranging result of the digital key is inside the vehicle (S30).

In the above determination step (S30) regarding the ranging result of the digital key, if the digital key is inside the vehicle, location authentication is performed (S40), and then the vehicle is started (S50) or a warning about the presence of the key in the vehicle is given (S60), but if the location of the digital key is not inside the vehicle, the vehicle may be configured to wait for another operation (S70).

In this way, when ranging (S10) of the digital key starts, a Pre-derived URSK is created (S20) on a regular basis, so that when location authentication (S40) is performed, occupation operation of unique security areas such as Secure Element may occur simultaneously in the vehicle digital key authentication controller.

Ultimately, when generating a pre-derived URSK (S20), the vehicle digital key authentication controller occupies the operation of the unique security area such as Secure Element, so when authenticating location (S40), the occupation operation of another Secure Element to authenticate whether the actual digital key is authorized to be used in the vehicle is carried out simultaneously, which may cause an operation delay due to collision or interference.

At this time, the operation delay of location authentication (S40) may result in a delay in operations such as vehicle starting, vehicle door locking/door unlocking, and warning, and operation cancellation may occur due to exceeding the location authentication waiting time.

### SUMMARY

The present disclosure is directed to providing a method for generating a pre-derived ultra wide band (UWB) ranging secure key (URSK) according to the ranging result of a digital key, which is configured to determine the time point of generation of each pre-derived URSK according to first to third locations of the digital key according to the ranging result of the digital key.

Further, various aspects of the present disclosure are directed to providing a vehicle digital key authentication controller configured to control the time point of generation of each pre-derived URSK according to first to third locations of the digital key according to the ranging result of the digital key through the execution of a computer program.

According to an embodiment of the present disclosure, there is provided a method for determining generation of a pre-derived ultra wide band ranging secure key (URSK) which is not interfered with location authentication of an active URSK according to a ranging result of a digital key, the method including: determining, by a digital key authentication controller, a location of a digital key in relation to a vehicle according to a UWB ranging; determining, by the digital key authentication controller, a time of generating the pre-derived URSK according to the locations of the digital key; and generating, by the digital key authentication controller, the pre-derived URSK according to the time.

Here, the generating of the pre-derived URSK according to the time may comprises generating the pre-derived URSK after a location authentication of an active URSK and starting the vehicle or warning of presence of a key inside the vehicle, in response that the digital key is determined to be located at a first location.

The generating of the pre-derived URSK according to the time may further include generating the pre-derived URSK after waiting until the UWB ranging is terminated, in response that the location of the digital key is moved from the first location to a second location during the location authentication of the active URSK.

The generating of the pre-derived URSK according to the time may further include generating the pre-derived URSK after waiting until the UWB ranging is terminated, in response that the location of the digital key is the second location.

The generating of the pre-derived URSK according to the time may further include generating the pre-derived URSK after a location authentication of the active URSK and starting the vehicle or warning of presence of a key inside the vehicle, in response that the location of the digital key is moved from the second location to the first location during the waiting.

The generating of the pre-derived URSK according to the time may further include immediately generating the pre-derived URSK, in response that the location of the digital key is moved from the second location to the third location during the waiting.

The generating of the pre-derived URSK according to the time may further include immediately generating the pre-derived URSK in response that the location of the digital key is a third location.

The generating of the pre-derived URSK according to the time may further include generating a pre-derived URSK for a first digital key, and then generating a pre-derived URSK for a second digital key or a pre-derived URSK for a third digital key, in response that it is determined that the first digital key is at a first location, and the second digital key is at a second location or the third digital key is at a third location.

The generating of the pre-derived URSK according to the time may further include generating a pre-derived URSK for the first digital key, generating a pre-derived URSK for the third digital key, and then generating a pre-derived URSK for the second digital key, in response that it is determined that the first digital key is at the first location, the second digital key is at the second location, and the third digital key is at the third location.

Herein, the generating of the pre-derived URSK for the first digital key is performed after a location authentication of an active URSK and starting the vehicle or warning of presence of a key inside the vehicle, the generating of the pre-derived URSK for the second digital key is performed after waiting until the UWB ranging is terminated, and the generating of the third digital key is immediately performed.

According to an embodiment of the present disclosure, there is provided a digital key authentication controller for a vehicle, which authenticates an active UWB ranging secure key (URSK) when a digital key is accessed, the digital key authentication controller including: a memory configured to store a computer program for authenticate; and at least one processor configured to execute the computer program, wherein the digital key authentication controller is configured to generate a pre-derived URSK according to a location of the digital key determined according to a UWB ranging through the execution of the computer program.

Herein, the digital key authentication controller may be further configured to generate the pre-derived URSK after a location authentication of an active URSK and starting the vehicle or warning of presence of a key inside the vehicle, in response that the digital key is determined to be located at a first location.

The digital key authentication controller may be further configured to generate the pre-derived URSK after waiting until the UWB ranging is terminated, in response that the location of the digital key is moved from the first location to a second location during the location authentication of the active URSK.

The digital key authentication controller may be further configured to generate the pre-derived URSK after waiting until the UWB ranging is terminated, in response that the location of the digital key is the second location.

The digital key authentication controller may be further configured to generate the pre-derived URSK after a location authentication of the active URSK and starting the vehicle or warning of presence of a key inside the vehicle, in response that the location of the digital key is moved from the second location to the first location during the waiting.

The digital key authentication controller may be further configured to generate the pre-derived URSK immediately in response that the location of the digital key is moved from the second location to the third location during the waiting.

The digital key authentication controller may be further configured to generate the pre-derived URSK immediately in response that the location of the digital key is a third location.

The digital key authentication controller may be further configured to generate a pre-derived URSK for a first digital key, and then generating a pre-derived URSK for a second digital key or a pre-derived URSK for a third digital key, in response that it is determined that the first digital key is at a first location, and the second digital key is at a second location or the third digital key is at a third location.

The digital key authentication controller may be further configured to generate a pre-derived URSK for the first digital key, generating a pre-derived URSK for the third digital key, and then generating a pre-derived URSK for the second digital key, in response that it is determined that the first digital key is at the first location, the second digital key is at the second location, and the third digital key is at the third location.

Herein, the digital key authentication controller may be further configured to generate the pre-derived URSK for the first digital key after location authentication of an active URSK and starting the vehicle or warning of presence of a key inside the vehicle, generate the pre-derived URSK for the second digital key waiting until the UWB ranging is terminated, and generate the third digital key immediately.

### BRIEF DESCRIPTION OF THE DRAWINGS

FIG. 1 is a flowchart illustrating a method for generating a pre-derived URSK of a digital key according to a conventional art.

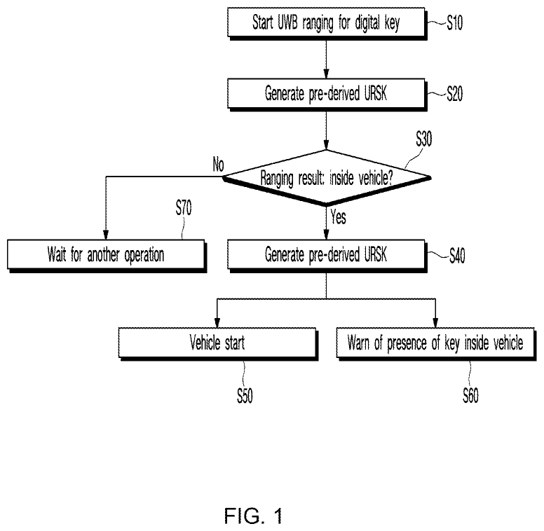

FIG. 2 is a flowchart illustrating a method for generating a pre-derived URSK according to the ranging result of a digital key according to an embodiment of the present disclosure.

FIG. 3 is a flowchart illustrating a method for generating a pre-derived URSK according to the ranging result of a digital key according to another embodiment of the present disclosure.

FIG. 4 is a flowchart illustrating a method for generating a pre-derived URSK according to the ranging result of a digital key according to further another embodiment of the present disclosure.

FIG. 5 is a block diagram illustrating a digital key authentication controller for a vehicle according to the present disclosure.

FIG. 6 is an explanatory diagram defining first to third locations of a digital key in a method for generating a pre-derived URSK according to the ranging result of the digital key and a digital key authentication controller for a vehicle according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Since various modifications may be applied to the present disclosure and there may be various embodiments, specific embodiments will be illustrated in the drawings and described in the present disclosure. However, this is not intended to limit the present disclosure to specific embodiments and should be understood to include all changes, equivalents or substitutes included in the spirit and technical scope of the present disclosure.

Suffixes “module” and “part” used herein are only used for the name distinction between components, and should not be interpreted as having a premise of physicochemical classification or separation.

Terms including ordinal numbers such as “first” and “second” may be used to explain various components, but the components are not limited by the terms. The terms may be used only in a name for distinguishing one component from another component, and the sequence between them is recognized by the context of the description, not by the names.

The term “and/or” is used to include all the cases of any combination of the plural items that are subject to the target. For example, “A and/or B” means all three cases of “A”, “B”, “A and B”.

When a component is referred to as “connected” or “linked” to another component, it may be directly connected to or linked to that another component, but it should also be understood that there may be further another component therebetween.

The terms used in the present disclosure are used to explain a particular embodiment, and are not intended to limit the present disclosure. A singular term in the present disclosure includes a plural term unless it is contextually, clearly means a singular form. In the present disclosure, the terms such as “include” or “have” are to specify that there are features, numbers, steps, operations, components or parts described in the present disclosure, or combinations thereof, and It should be understood that the presence or the possibility of addition of numbers, steps, operations, components, part, or combinations thereof are not excluded in advance.

Unless defined differently, all the terms used here, including technical or scientific terms, have the same meaning as commonly understood by those who have normal knowledge in the technical field to which the present disclosure belongs. Terms such as what are commonly used in the dictionary should be interpreted as having the meaning of the context of the relevant technology, and are not interpreted as an ideal or excessively formal meaning unless defined clearly in the present disclosure.

In addition, “unit”, “control unit”, “control device” or “controller” is a term widely used as a name of a device that controls its function, and does not mean a general function unit. For example, a device, which uses one of the above names, may include a communication device which communicates with another controller or sensor for control of the function, a recording medium which may be read by a computer that stores an operating system, a logic command, and input and output information, etc., and one or more processors which perform judgment, operations, and decisions required for the function control.

Further, a processor may include a semiconductor integrated circuit and/or electronic devices that perform at least one or more of comparison, judgment, operation, and decision to achieve a programmed function. For example, the processor may be any one or a combination of a computer, a micro processor, CPU, ASIC, and an electronic circuits (circuitry, logic circuits).

In addition, a recording medium readable by a computer (or briefly called a memory) includes all kinds of storage devices that may be read by a computer system. For example, the storage medium may include at least one of a flash memory, a hard disk type memory, a micro type memory, a card type memory, a secure digital (SD) card, an extreme digital (XD) card, a random access memory (RAM), a static RAM, a read-only memory (ROM), a programmable ROM (PROM), an electrically erasable PROM (EEPROM), a magnetic RAM (MRAM), a magnetic disk type memory, and an optical disk type memory.

Such a recording medium may be electrically connected to a processor, and the processor may load and record data from the recording medium. A recording medium and a processor may be integrated or physically separated.

Hereinafter, preferred embodiments of the present disclosure will be described in more detail with reference to the attached drawings.

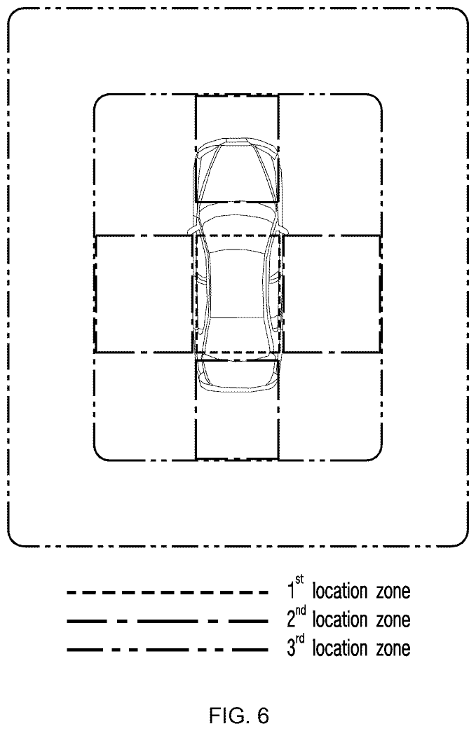

First, in a method for generating a pre-derived URSK according to the ranging result of a digital key, and a digital key authentication controller for a vehicle for the same according to the present disclosure, the location of the digital key measured in real time through UWB-based ranging may be determined according to which zone the key belonging to among a first location zone, a second location zone, and a third location zone, as shown in FIG. 6.

Here, the first location zone may be defined as a zone where location authentication for vehicle start or warning is essential, and may be limited to the interior of the vehicle.

In addition, the second location zone may be defined as a zone which covers a frunk of a vehicle and an area within 1 to 2 m from the frunk in the front, a trunk of the vehicle and an area within 1 to 2 m from the trunk in the rear, and areas within 1 to 2 m from the vehicle in the left and right sides, where no location authentication operation occurs, but is expected that the driver holding the key can quickly move to the first location zone at any time.

In addition, the third location zone may be defined as an area in which no location authentication operation occurs, but it takes at least several seconds for the driver to move to the first location zone via the second location zone, and may be limited to an area within 2.5 to 5.5 m from the front, back, left and right sides of the vehicle.

In the method for generating a pre-derived URSK according to the ranging result of a digital key according to an embodiment of the present disclosure, a pre-derived URSK may be generated to prevent interference or collision in the operation during the location authentication of an active UWB ranging secure key (URSK) according to the ranging result of the digital key.

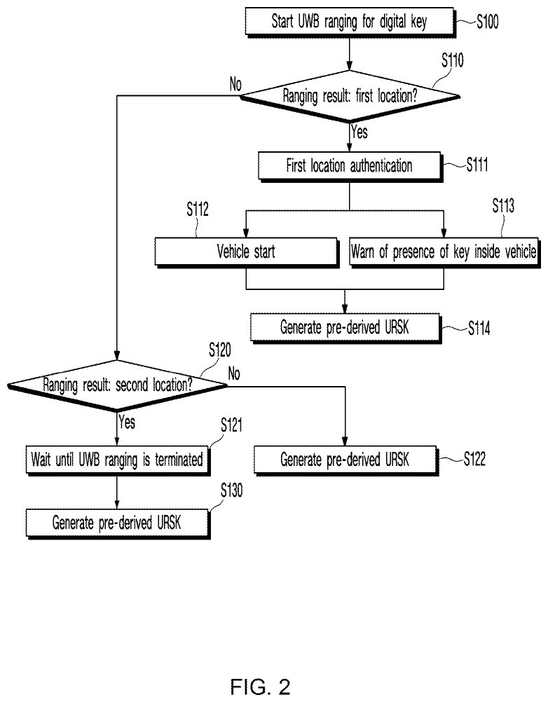

At this time, in a method for generating a pre-derived URSK according to the ranging result of a digital key according to an embodiment of the present disclosure, as illustrated in FIG. 2, after the ranging of the digital key (S100), it is determined whether the location of the digital key is the first location (S110). If the location of the digital key is the first location, the location authentication for the active URSK for the first location may be performed (S111), the vehicle may then be started (S112) or a warning of the presence of a key in the vehicle may then be given (S113), and a pre-derived URSK may then be generated (S114).

However, in the method for generating a pre-derived URSK according to the ranging result of a digital key according to an embodiment of the present disclosure, if it is determined the location of the digital key is not the first position in the first location determination step of the digital key (S110), it may secondarily be configured to determine the location of the digital key in the second location determination step of the digital key (S120).

Here, if it is determined that the location of the digital key is the second location in the second location determination step of the digital key (S120), the digital key may be moved to the first location at any time. As such, a standby state may be maintained (S121) until the ranging is terminated, and a pre-derived URSK may then be generated (S122).

In particular, if it is determined that the location of the digital key is the third location in the second location determination step of the digital key (S120), the movement of the digital key to the first location may take several seconds, and there is no possibility of location authentication within a few seconds, so a pre-derived URSK may be generated (S130) immediately after the determination of the location of the digital key.

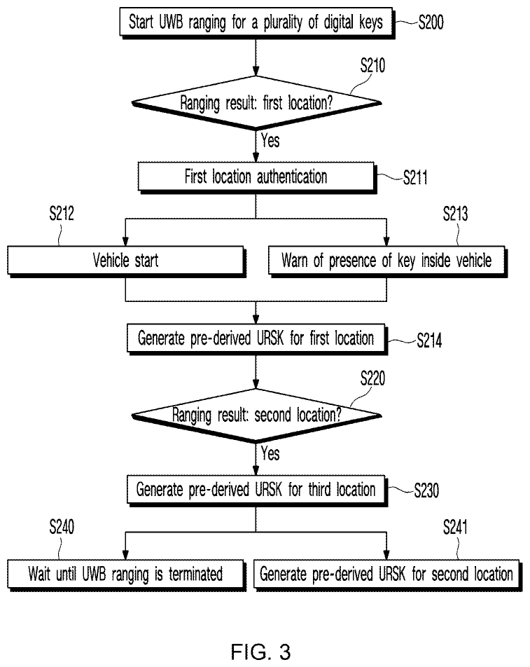

In addition, in a method for generating a pre-derived URSK according to the ranging result of a digital key according to another embodiment of the present disclosure, as illustrated in FIG. 3, after the ranging for 2 or more digital keys (S200), if it is determined that the location of the first digital key is the first location in the location determination step (S210) of the first digital key, the first location authentication for the active URSK is performed (S211), the vehicle may then be started (S212) or a warning of the presence of a key in the vehicle may then be given (S213), and a pre-derived URSK for the first digital key may then be generated (S214).

In addition, in the method for generating a pre-derived URSK according to the ranging result of a digital key according to another embodiment of the present disclosure, when a pre-derived URSK for the first digital key is generated (S214), it may be determined whether the second digital key is at the second location and/or the third digital key is at the third location in the location determination step (S220) for the second digital key.

At this time, if only the presence of the second digital key at the second location is determined in the location determination step (S220) for the second digital key, a standby state may be maintained (S240) until the ranging is terminated, and if only the presence of the third digital key at the third location is determined in the location determination step (S220) for the second digital key, a pre-derived URSK may be generated (S230) immediately after the determination of the location of the digital key.

However, if both the presence of the second digital key at the second location and the presence of the third digital key at the third location are determined in the location determination step (S220) for the second digital key, a pre-derived URSK for the third digital key at the third location may be generated (S230) immediately after the location determination, then a standby state may be maintained (S240) until the ranging is terminated, and a pre-derived URSK for the second digital key at the second location may then be generated (S241).

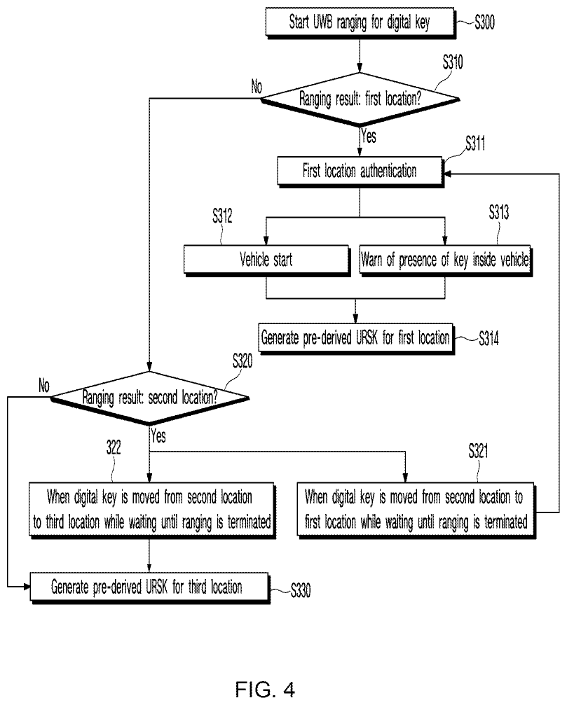

Further, in a method for generating a pre-derived URSK according to the ranging result of a digital key according to another embodiment of the present disclosure, as illustrated in FIG. 4, after the ranging of the digital key (S300), it is determined whether the location of the digital key is the first location (S310). If the location of the digital key is the first location, the location authentication for the active URSK for the first location may be performed (S311), the vehicle may then be started (S312) or a warning of the presence of a key in the vehicle may then be given (S313), and a pre-derived URSK may then be generated (S314).

Here, if the location of the digital key is moved from the first location to the second location while the location authentication for the active URSK for the first location is performed (S311), the digital key at the second location may be at a standby state until the ranging is terminated, and a pre-derived URSK may then be generated.

However, if it is determined the location of the digital key is not the first position in the first location determination step of the digital key (S310), the second location or the third location of the digital key may be determined in the second location determination step of the digital key (S320).

At this time, if it is determined that the digital key is found at the second location in the second location determination step (S320) of the digital key, the digital key at the second location may be moved to the first location at any time, and accordingly, a standby state may be maintained until the ranging is terminated. if the digital key is moved to the first location (S321) in the standby state, the first location authentication (S311) may be promptly performed, and if the digital key is moved to the third location in the standby state, a pre-derived URSK may be promptly generated (S330) at the third location.

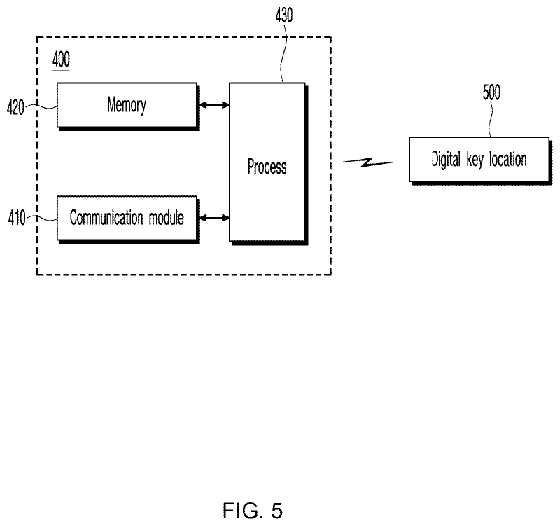

Further, as illustrated in FIG. 5, a digital key authentication controller 400 for a vehicle according to the present disclosure may include a communication module 410 configured to receive real-time location signals of the digital key based on UWB, a memory 420 configured to store a computer program for the location authentication of an active URSK, and at least one processor configured to execute a computer program stored in the memory 420.

The communication module 410 of the digital key authentication controller 400 for a vehicle may be a hardware component implemented with various electronic circuits to determine the location of the digital key in real time through UWB communication.

The memory 420 of the digital key authentication controller 400 for a vehicle may be various forms of recording media which ma store a computer program for location authentication of the active URSK for the digital key of which the location has been determined as the first location.

In addition, the process 430 of the digital key authentication controller 400 for a vehicle may be performed to determine when each pre-derived URSK is generated according to the first to third locations of the digital key according to the ranging result by executing a computer program stored in the memory 420.

In addition, in the digital key authentication controller 400 for a vehicle, if the location of the digital key is the first location as a result of the ranging operation, a pre-derived URSK may be generated after the vehicle start or warning of presence of a key inside the vehicle together with the location authentication of the active URSK.

Here, in the digital key authentication controller 400 for a vehicle, if the location of the digital key is moved from the first location to the second location during the authentication operation of the active URSK, a standby state may be maintained until the end of the ranging operation is terminated, and a pre-derived URSK may then be generated.

In particular, in the digital key authentication controller 400 for a vehicle, as a result of the ranging operation for two or more digital keys, if it is determined that the first digital key is at the first location, and the second digital key is at the second location or the third digital key is at the third location, a pre-derived URSK for the first digital key may be generated, and a pre-derived URSK for the second digital key or a pre-derived URSK for the third digital key may then be generated.

In addition, in the digital key authentication controller 400 for a vehicle, as a result of the ranging operation for two or more digital keys, if it is determined that the first digital key is at the first location, the second digital key is at the second location and the third digital key is at the third location, a pre-derived URSK for the first digital key may be generated, then a pre-derived URSK for the third digital key may be generated, and then a pre-derived URSK for the second digital key may be generated.

In particular, in the digital key authentication controller 400 for a vehicle, a pre-derived URSK for the first digital key may be generated after a vehicle start or warning of presence of a key inside the vehicle together with the authentication of the active URSK, a pre-derived URSK for the second digital key may be generated after a standby state is maintained until the end of the ranging operation, and a pre-derived URSK for the third digital key may be promptly generated.

As described above, preferred embodiments according to the present disclosure have been examined, and it is obvious to those skill in the art that the present disclosure can be embodied in other specific forms in addition to the embodiments described above without departing from the spirit or scope thereof. Therefore, the above-described embodiments are to be regarded as illustrative and not restrictive, and thus the present disclosure is not limited to the above description but may be modified within the scope of the appended claims and their equivalents.

What is claimed is:

1. A method of generating a pre-derived ultra wide band (UWB) ranging secure key (URSK), the method comprising:
determining, by a digital key authentication controller, a location of a digital key in relation to a vehicle according to a UWB ranging;
determining, by the digital key authentication controller, a time of generating the pre-derived URSK according to the locations of the digital key; and
generating, by the digital key authentication controller, the pre-derived URSK according to the time.

2. The method of claim 1, wherein generating the pre-derived URSK according to the time comprises:
generating the pre-derived URSK after a location authentication of an active URSK and starting the vehicle or warning of presence of a key inside the vehicle, in response that the digital key is determined to be located at a first location.

3. The method of claim 2, wherein generating the pre-derived URSK according to the time further comprises:
generating the pre-derived URSK after waiting until the UWB ranging is terminated, in response that the location of the digital key is moved from the first location to a second location during the location authentication of the active URSK.

4. The method of claim 1, wherein generating the pre-derived URSK according to the time comprises:
generating the pre-derived URSK after waiting until the UWB ranging is terminated, in response that the location of the digital key is the second location.

5. The method of claim 4, wherein generating the pre-derived URSK according to the time further comprises:
generating the pre-derived URSK after a location authentication of the active URSK and starting the vehicle or warning of presence of a key inside the vehicle, in response that the location of the digital key is moved from the second location to the first location during the waiting.

6. The method of claim 4, wherein generating the pre-derived URSK according to the time further comprises:
immediately generating the pre-derived URSK, in response that the location of the digital key is moved from the second location to the third location during the waiting.

7. The method of claim 1, wherein generating the pre-derived URSK according to the time comprises:
immediately generating the pre-derived URSK in response that the location of the digital key is a third location.

8. The method of claim 1, wherein generating the pre-derived URSK according to the time comprises:
generating a pre-derived URSK for a first digital key, and then generating a pre-derived URSK for a second digital key or a pre-derived URSK for a third digital key, in response that it is determined that the first digital key is at a first location, and the second digital key is at a second location or the third digital key is at a third location.

9. The method of claim 8, wherein generating the pre-derived URSK according to the time further comprises:
generating a pre-derived URSK for the first digital key, generating a pre-derived URSK for the third digital key, and then generating a pre-derived URSK for the second digital key, in response that it is determined that the first digital key is at the first location, the second digital key is at the second location, and the third digital key is at the third location.

10. The method of claim 8,
wherein the generating of the pre-derived URSK for the first digital key is performed after a location authentication of an active URSK and starting the vehicle or warning of presence of a key inside the vehicle, the generating of the pre-derived URSK for the second digital key is performed after waiting until the UWB ranging is terminated, and the generating of the third digital key is immediately performed.

11. A digital key authentication controller for a vehicle, which authenticates an active ultra wide band (UWB) ranging secure key (URSK) when a digital key is accessed, the digital key authentication controller comprising:
a memory configured to store a computer program for authentication; and
at least one processor configured to execute the computer program,
wherein the digital key authentication controller is configured to generate a pre-derived URSK according to a location of the digital key determined according to a UWB ranging through the execution of the computer program.

12. The digital key authentication controller of claim 11,
wherein the digital key authentication controller is further configured to generate the pre-derived URSK after a location authentication of an active URSK and starting the vehicle or warning of presence of a key inside the vehicle, in response that the digital key is determined to be located at a first location.

13. The digital key authentication controller of claim 12,
wherein the digital key authentication controller is further configured to generate the pre-derived URSK after waiting until the UWB ranging is terminated, in response that the location of the digital key is moved from the first location to a second location during the location authentication of the active URSK.

14. The digital key authentication controller of claim 11,
wherein the digital key authentication controller is further configured to generate the pre-derived URSK after waiting until the UWB ranging is terminated, in response that the location of the digital key is the second location.

15. The digital key authentication controller of claim 14,
wherein the digital key authentication controller is further configured to generate the pre-derived URSK after a location authentication of the active URSK and starting the vehicle or warning of presence of a key inside the vehicle, in response that the location of the digital key is moved from the second location to the first location during the waiting.

16. The digital key authentication controller of claim 14,
wherein the digital key authentication controller is further configured to generate the pre-derived URSK immediately in response that the location of the digital key is moved from the second location to the third location during the waiting.

17. The digital key authentication controller of claim 11,
wherein the digital key authentication controller is further configured to generate a pre-derived URSK for a first digital key, and then generating a pre-derived URSK for a second digital key or a pre-derived URSK for a third digital key, in response that it is determined that the first digital key is at a first location, and the second digital key is at a second location or the third digital key is at a third location.

18. The digital key authentication controller of claim 17,
wherein the digital key authentication controller is further configured to generate a pre-derived URSK for the first digital key, generating a pre-derived URSK for the third digital key, and then generating a pre-derived URSK for the second digital key, in response that it is determined that the first digital key is at the first location, the second digital key is at the second location, and the third digital key is at the third location.

19. The digital key authentication controller of claim 17,
wherein the digital key authentication controller is further configured to generate the pre-derived URSK for the first digital key after location authentication of an active URSK and starting the vehicle or warning of presence of a key inside the vehicle, generate the pre-derived URSK for the second digital key waiting until the UWB ranging is terminated, and generate the third digital key immediately.

20. A vehicle comprising the digital key authentication controller of claim 11.
